(19) United States
(12) Patent Application Publication
(10) Pub. No.: US 2008/0034435 A1
(43) Pub. Date: Feb. 7, 2008

(54) Methods and arrangements for detecting and managing viewability of screens, windows and like media

(75) Inventors: Genady Grabarnik, Scarsdale, NY (US); Nagui Balim, Yorktown Heights, NY (US); Neal M. Keller, Pleasantville, NY (US); Lev Kozakov, Stamford, CT (US); Larisa Shwartz, Scarsdale, NY (US); Clifford A. Pickover, Yorktown Heights, NY (US); Robert W. Wisniewski, Ossining, NY (US)

Correspondence Address: FERENCE & ASSOCIATES LLC, 409 BROAD STREET, PITTSBURGH, PA, 15143, US

(73) Assignee: IBM Corporation, Armonk, NY (US)

(21) Appl. No.: 11/499,217

(22) Filed: Aug. 3, 2006

(51) Int. Cl. G06F 11/00

(52) U.S. Cl. 726/25

(57) ABSTRACT

In the context of screens, windows and like media, arrangements for automatically detecting when a recipient has entered or left a public setting so that privacy configuration changes can be automatically invoked. Also broadly contemplated herein is an arrangement for selectively displaying messages on the recipient's screen but deferring the messages from being visible on a remote hardware device or software display which is publicly visible. Furthermore, there is broadly contemplated herein a secure arrangement for revealing and responding to deferred messages. More generally, there is broadly contemplated herein a new approach to the provision of application notifications and to alarm control during a desktop screen sharing mode, based on the automatic detection of a screen sharing state and on notifying registered applications of the screen sharing in a unified, consistent manner.

### FIELD OF THE INVENTION

The present invention relates generally to problems and issues encountered when screens, windows and like media are potentially viewable by unauthorized individuals, with whom the sharing of potentially sensitive information, e.g., as might be present in an incoming instant message, might not be desired.

### BACKGROUND OF THE INVENTION

Instant messaging (IM) systems, such as those provided by America-on-Line Instant Messager (AIM), Yahoo Messenger, Lotus Sametime, etc. are widespread and utilized in personal and professional environments. In some countries, text messaging usage of cell phones exceeds usage for phone calls. Corporations have encouraged employees to make extensive use of instant messaging to facilitate rapid decision making. Technology providers such as IBM and others sell infrastructure services which provide secure instant messaging.

Unfortunately, the increasing use of instant messaging systems in public settings such as airports and coffee shops raises the possibility that a personally or business sensitive message may be displayed on a user's screen when they are physically co-located with others or projecting their computer screen during a Web based business meeting, thus raising privacy concerns. Airlines are beginning to provide wireless Internet access during flights during which much business is conducted in situations allowing little privacy from passengers in adjacent seats.

Some features of existing instant messaging systems address privacy concerns by enabling recipients to block all messages, to indicate that they are busy and should not be disturbed, or to only allow certain senders to see that the recipient is online. Other systems provide options to alert the recipient by a sound or by a blinking task bar so that the text of messages is not immediately visible without further action on the part of the recipient. Yet other systems take some of the burden of privacy protection from the recipient by providing them with the option to have their status automatically changed when they do or do not perform some action with their computer. For example, a recipient's status can be automatically changed from active to inactive, and a customized message displayed to potential senders of instant messages, when recipients do not use their keyboard or mouse for a specified period of time.

Such systems are not designed, however, for situations in which the recipient is continuing to use their keyboard and mouse as they move between private and public settings or briefly and spontaneously decide to project their computer screen during Web based business meetings. Existing systems do not adapt automatically to these rapid changes in privacy circumstances without burdening the recipient with frequent and distracting manual changes in their instant messaging privacy configurations. Existing systems either provide advisory warnings which may be ignored by senders or overly reduce the usefulness of instant messaging by unduly restricting access by senders to recipients, thus making the recipients unnecessarily appear to be often unavailable and unresponsive.

By way of a more general set of analogous problems, desktop screen sharing on workstations normally requires special settings or notifications in personal communication programs, like instant messenger, e-mail, redirected phone mail, etc. in order to prevent certain applications or personal data from being shared with others (e.g., via a projector or large screen). However, currently, such applications are not normally able to detect a condition of desktop screen sharing. Accordingly, any user who wants to share a desktop screen normally needs to take special action to protect applications or data that are not intended for sharing. For example, a user who needs to share a desktop may not want to share instant text messages or voice messages arriving in real-time (a situation aptly illustrated in FIG. 1).

Conventional approaches for attending to such a problem involve changing the communication settings, or sending notifications to a second party through an explicit manual action in each of the applications. As the number of real-time communication/notification applications increases, however, the procedure of changing settings in multiple applications (and/or exiting some of those) becomes a progressively more time-consuming process. In addition, uncontrolled desktop screen sharing may result in the inadvertent disclosure of sensitive information.

In view of the foregoing, needs has been recognized in connection with, among other things, ensuring that instant messaging recipients can be maximally available for important instant messages while avoiding the display of personally or business sensitive messages while in public settings. Needs have also been recognized in connection with improving upon more general problems such as the viewability of screens or windows in public settings, to the extent that such screens or windows might be prone to display instant messages or other media that might contain sensitive information not meant for public disclosure.

### SUMMARY OF THE INVENTION

There is broadly contemplated herein, in accordance with at least one presently preferred embodiment of the present invention, an arrangement for automatically detecting when a recipient has entered or left a public setting so that privacy configuration changes can be automatically invoked, and in effortless manner, without burdening the recipient. Also broadly contemplated herein is an arrangement for selectively displaying messages on the recipient's screen but deferring the messages from being visible on a remote hardware device or software display which is publicly visible. Furthermore, there is broadly contemplated herein a secure arrangement for revealing and responding to deferred messages.

More generally, there is broadly contemplated herein, in accordance with at least one presently preferred embodiment of the present invention, a new approach to the provision of application notifications and to alarm control during a desktop screen sharing mode, based on the automatic detection of a screen sharing state and on notifying registered applications of the screen sharing in a unified, consistent manner.

Possible applications of the embodiments of the present invention, as disclosed herein, include applications for business travelers as well as for individuals using text messaging for personal communication. The devices employed could be, e.g., desktop computers, laptops, PDAs or cell phones with Internet access.

In summary, one aspect of the invention provides an apparatus for managing viewability of displayable items, the apparatus comprising: an arrangement for automatically ascertaining whether a displayable item is viewed or potentially viewable by at least one unauthorized individual; and an arrangement for managing viewability of a displayable item, responsive to the ascertaining arrangement.

Another aspect of the invention provides a method of managing viewability of displayable items, the method comprising the steps of: automatically ascertaining whether a displayable item is viewed or potentially viewable by at least one unauthorized individual; and managing viewability of a displayable item, responsive to the ascertaining step.

Furthermore, an additional aspect of the invention provides a program storage device readable by machine, tangibly embodying a program of instructions executable by the machine to perform method steps for managing viewability of displayable items, the method comprising the steps of: automatically ascertaining whether a displayable item is viewed or potentially viewable by at least one unauthorized individual; and managing viewability of a displayable item, responsive to the ascertaining step.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 illustrates an instant message “interrupting” a shared presentation.

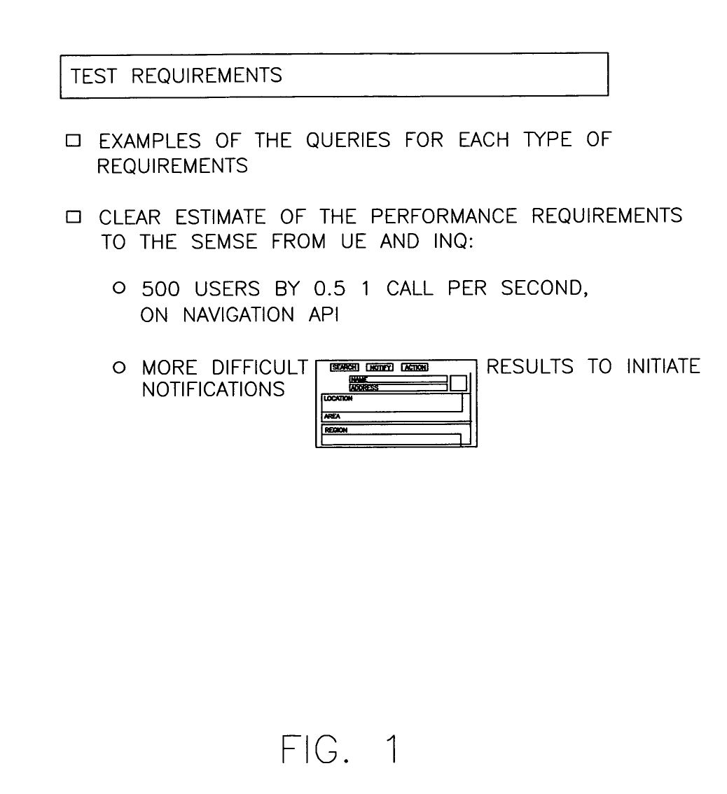

FIG. 2 provides a general system flowchart.

FIG. 3 illustrates a window for applying screen sharing event preferences.

### DESCRIPTION OF THE PREFERRED EMBODIMENTS

The present disclosure will first address specific challenges encountered with instant messaging and then will turn to more general scenarios in virtually any screen or window-based setting where the display of sensitive information at given times or in given situations might be undesirable.

Broadly contemplated herein, in accordance with at least one presently preferred embodiment of the present invention, is an arrangement for detecting when the recipient of an instant message is in a public setting, and then to defer messages from being visible to others until the recipient has the opportunity to reveal and respond to them consistent with his/her privacy preferences.

In situations where the text messaging recipient has begun to share his/her computer screen during a Web based business meeting, such detection is preferably based on coordinating the instant messaging client with the screen-sharing client so the instant messages are only displayed on the native client but not on the remote display, whether the remote display is a projector or screen sharing software, whenever a screen sharing client is invoked by the recipient. This change would occur automatically and effortlessly from the perspective of the recipient.

The present invention, in accordance with at least one preferred embodiment, allows for the remote device to be another hardware display such as a projector, television, separate monitor, etc., or to be a remote software display such as screen shared by PC anywhere, vnc, emeeting, etc. The hardware device is handled by providing a different set of pixels for the buffer of the remote device as compared with the local screen, while the remote software display is handled by streaming a different set of pixels. In another embodiment, the pixels representing the instant messaging window(s) are simply not transmitted. A variant embodiment involves providing the missing pixels as if the instant messages window(s) were not there. Currently available web conferencing systems, for example, enable recipients to only share specific applications or frames but fail to provide the missing pixels as if the instant messaging window(s) were not there.

The frame buffer is a piece of memory from which the graphics card reads bits and displays them to the screen. A major difference involved in displaying images on a laptop screen, as opposed to a projector, is found in that the frame buffer is divided up and different bits are written to each “piece”. In such an eventuality, it is sometimes the case that full resolution with full color depth is unattainable. Accordingly, to the extent that special challenges are presented in a laptop environment, there is broadly contemplated herein, in accordance with at least one embodiment of the present invention, a separate frame buffer that can be accessed by programs aiming to provide a display on a remote screen (e.g., projector, vnc, emeeting, etc.) and that can open the interface to different buffers to a higher layer of software so that management software could then be programmed to a GUI to allow the user to choose (or learn) which bits to write to which buffer, and thus which bits to display to which screen. Thus, the capability of extending this functionality to a set of windows associated with a given application can easily be accomplished by the software. To do so, the software tracks the windows associated with the given application that is intended for a particular buffer and writes the bits for each of those windows to that buffer. For the buffer where the windows are not intended, the original set of bits remain unmodified. This capability can also clearly be extended to a set of windows from collections of applications. Alternatively, multiple displays implemented fully by software could use the standard frame buffer and this application's mechanisms (i.e., tracking which windows and thus which pixels should be in each display) to provide the same functionality.

In situations where the recipient is only using a native client, but not a remote display, in a public setting such as an airport waiting room with unauthorized individuals nearby, detection can be accomplished via a built in webcam which identifies that more than two eyes, or eyes other than the owner of the computer, are looking at the screen. Publicly available systems, some employing biometric arrangements, enable the tracking of eye gaze, focus and movements. (For example, the eyegaze analysis system by LC Technologies [http://www.eyegaze.com/2Products/Development/Developmentmain.htm] and eye tracking services by Blooming Software [http://www.ergosign.de/en/user-centred-design/usability-testing/eye-tracking.php] provide details on how the focus of eyes moves over a computer screen. Security related technologies developed by companies such as A4Vision Inc., a provider of 3-D facial-scanning and -recognition software and equipment [http://www.a4vision.com/], could be adapted for commercial privacy applications such as that described herein.) In such situations, the recipient's viewing of instant messages would be deferred until the recipient could reveal and respond to them. A polite message could preferably be sent automatically back to the sender, dependent on the context of the person deferring the text message, without having to be specified explicitly.

The system provides a number of alternatives to enable recipients to securely reveal and respond to deferred instant messages. For example, the recipient could swipe an icon representing the deferred message with a mouse and then key in a cipher lock to prevent accidentally revealing the message. The color of the border of the deferred instant message or another indicator of importance based on the identify of the sender or the subject of the message, as determined by text analysis, could highlight high priority deferred instant messages for a quicker response when privacy issues are no longer a concern. Alternatively, an arrangement could be provided for confirming the importance of incoming text messages and responding to them immediately without exposing them publicly. For example, based on predefined criteria such as the identity of the sender or a text analysis of the subject matter, the text message could be routed to a different communications channel such as an audio file or phone message where the text message could be listened to securely with headphones. Prior to the routing of the incoming text message to a different, secure communications channel, the sender of the text message could be asked to confirm the importance of the message. If a message is not urgent, it could be automatically routed to email for later review when the recipient is not in a public setting.

More specifically, a system configured in accordance with at least one embodiment of the present invention could: create a group instant message for a response by the recipient; consolidate the separate instant messages for easy reading (wherein the user could separate them again in order to respond to only some); or compare the instant messages along some dimension (content, management chain of senders, etc.) to inform a subsequent response decision (e.g., whom to respond to first, take the background provided by one individual and use it to inform the response to the second individual if the subjects were related, etc.) In accordance with at least one embodiment of the present invention, it is conceivable to make use of known approaches on known devices (e.g., ThinkPads) that conventionally permit a user to manually configure two displays (e.g., a first screen on a ThinkPad and a second screen on an LCD projector) so that information on a first screen is not shown on a second screen. However, it should be understood that, in accordance with at least one embodiment of the present invention, the display of instant messages on a public (e.g., projected) screen is automatically prevented while (in accordance with predetermined criteria) still being allowed on a private screen (e.g., on a ThinkPad monitor) so that a user can see important messages without the embarrassment of having them viewed on a public screen.

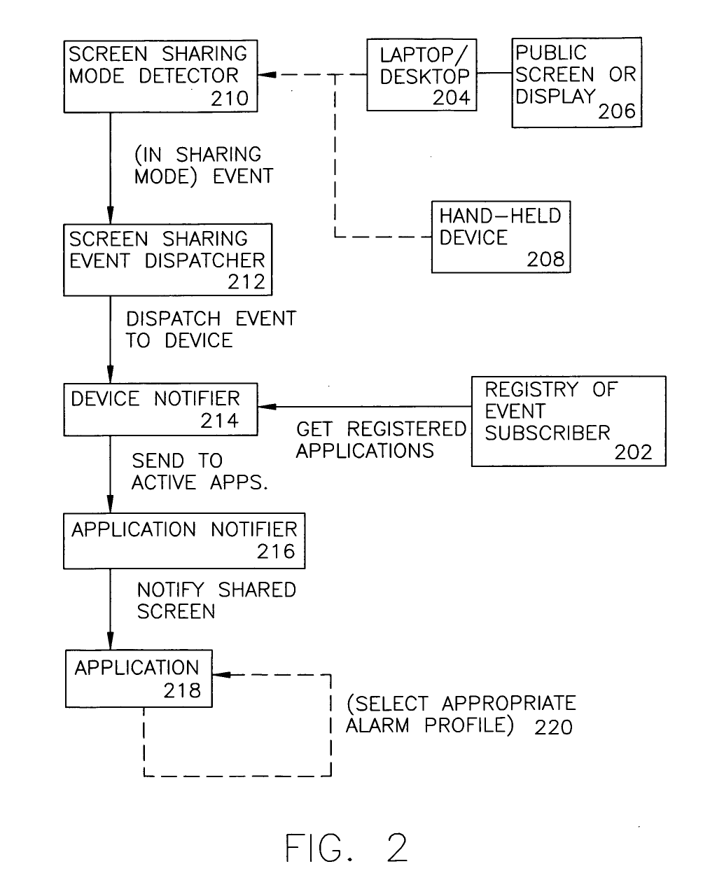

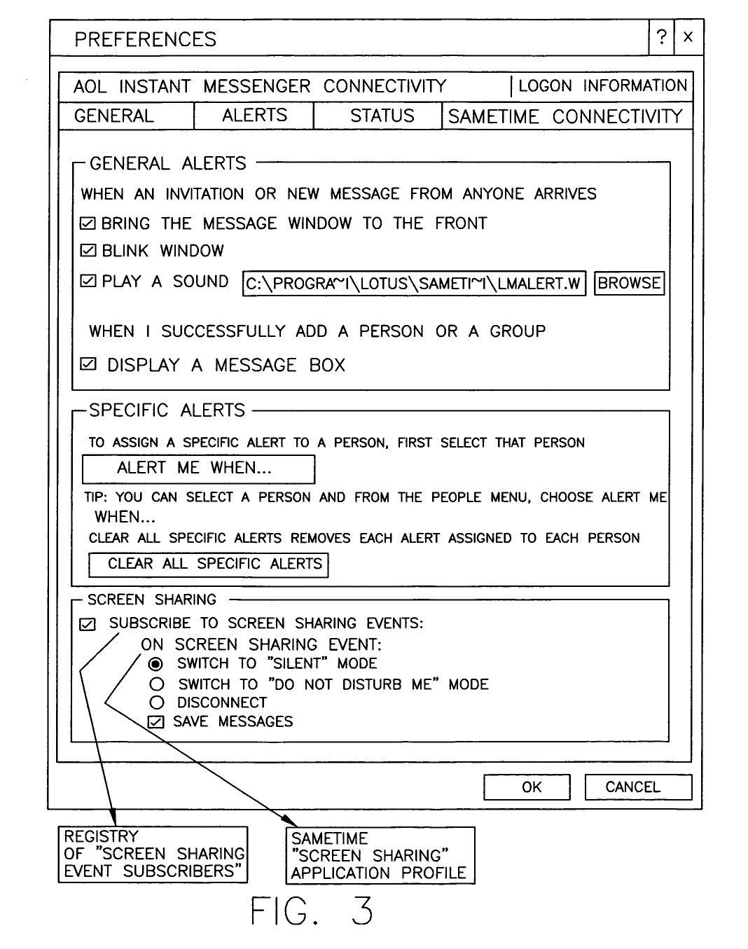

The disclosure now turns to more general considerations and, as needed, makes reference to FIGS. 2 and 3. It should be understood that FIGS. 2 and 3 are applicable to the discussion hereinabove as well as to the subject matter discussed herebelow.

As such, FIG. 2 provides a flowchart of a general process in accordance with a preferred embodiment of the present invention. In accordance with a preferred embodiment of the present invention, applications that need to be aware of desktop screen sharing will preferably register themselves in a special “screen sharing event subscription” system registry (202). Examples of such applications could include, but are not limited to, e.g., LotusNotes, Sametime Client, Notes Buddy, etc.

Preferably, a desktop or laptop screen sharing state (e.g., where a laptop or desktop 204 is to share a screen with a “public” viewing device such as a large screen or projection device 206) can be detected automatically (210). Preferably, but not necessarily, full desktop screen sharing is detected as opposed to the mere sharing of a given application window. Preferably, automatic screen sharing detection is based on an analysis of the activity of hardware modules and of software applications that enable screen sharing but of course could be accomplished by analogous means. In the case of a cell phone, PDA or other hand-held device 208, “screen sharing” can be understood as a situation in which a public setting (e.g., airport terminal, coffee shop) has been entered and the potential exists for unauthorized individuals to view the face or screen of the hand-held device, as discussed hereinabove. It should be understood that as cell phones, PDAs and similar devices become more powerful and include Internet access, the same screen projection via hardware or software as just described can present an additional “privacy exposure” to that (as previously described) of unauthorized individuals directly viewing the face or screen of the hand-held device.

Preferably, the notification of screen sharing events is dispatched in a unified manner to subscribed applications (212, 214). This allows the applications to automatically tune or tailor their settings/behavior in response to the screen sharing event notification. (For example, LotusNotes may act to hide certain e-mails, or a Notes Buddy client may act to turn off pop-up messages or voice reading, etc.) Also, at 216/218, a workstation/desktop user can specify notification settings for appropriate applications (e.g., via choosing from a set of notification profiles) to ensure that, while in the screen-sharing mode, certain windows or data would not be shared. Given the application (218) at hand, an appropriate alarm profile can be selected (220).

Screen sharing could be realized using port replicator and/or software applications (or components thereof). In the context of a port replicator, the system preferably provides software and APIs that permit the control and detection of current screen sharing. IBM's ThinkPad, for example, has a Presentation Director that permits the definition of screen sharing profiles and detects a screen sharing mode. This API could be used for detection. For example, the user may define a special Presentation Director profile for projecting a desktop to a large shared screen. The Screen Sharing Mode Detector 210 analyzes Presentation Director activity and generates a ScreenSharing event, if the Presentation Director activates this profile. If sharing is done via another software application or component, such as VNC, MSN Messenger, MS NET Meeting, etc., the detection could be accomplished by analyzing the activity of such an application, for instance, assessing the changes in CPU usage within a given period of time. As such, CPU utilization tends to increase when screen-changing operations are performed on the system sharing the screen. The Screen Sharing Mode Detector 210 can maintain a list of applications that may enable screen sharing. This list may be updated from time to time by the user or automatically.

Accordingly, by way of brief review, there is broadly contemplated herein a unified approach to notifications and alarm handling as controlled by system level components. This component dispatches a ScreenSharing event to active subscribed applications at the System level by using System Event Dispatcher (212), Desktop Notifier (214) and Application Notifier (216) modules. The Desktop Notifier (214) identifies subscribed applications currently active on the desktop. The Application Notifier (216) dispatches the notification to each of the identified applications. FIG. 3 illustrates a conceivable implementation of a screen sharing profile configuration in SameTime client preferences. (“SameTime” client preferences are used to enable customization of the instant messaging client. They enable the user to specify how notification of new messages should be provided visually and/or auditorially on their desktop or PDA. In addition, users can indicate if specific types of notifications should be used for selected users either for purposes of being sure to pay attention to the instant message or to make it a very low priority. For example, a user might want instant messages only from their manager to blink. In the example shown in FIG. 3, “silent” mode could be defined as minimizing the instant messaging window with no sound or blinking.) It will be appreciated from the foregoing that broadly contemplated herein are:
a novel method of preventing inadvertent disclosure of personal/sensitive information during desktop screen sharing sessions;
a novel process of automatically detecting a screen sharing mode and notifying registered applications;
a novel system event, namely the Screen Sharing event, that is dispatched to registered applications by way of providing notification of a screen sharing mode.

It will further be appreciated that the embodiments of the present invention can be employed in a wide variety of applications which may include, but by no means are limited to:
corporate presentations, where there can often be a risk of disclosing confidential or personal information when a mail client or instant messenger might suddenly “pop up” with a new message;
sales presentations, where customers sometimes can be involuntary apprised of confidential information; and
an e-meeting environment, where participants may need to share a desktop without closing a mail client or instant messenger.

In brief recapitulation, it will be even further appreciated that there are described and broadly contemplated herein several instant messaging privacy services which detect particular privacy concerns, and automatically take particular privacy actions in response to detection of the concerns. The privacy concerns, among other things, could be any or all of, e.g.: the projection of a device screen (as determined by sensing projection) via hardware (for example, presentation) or software (for example, VNC/online meeting screen sharing); unauthorized human viewers (for example, as detected by camera-based eye tracking); and the presence of sensitive IM content (for example as determined by an analysis of such text, audio or video).

The privacy actions could be embodied, among other things, by any of, e.g.: displaying the IM only on the primary device screen while permitting screen projection via hardware or software to continue simultaneously without an IM, by automatically filling in missing pixel values; or restricting access to IM content with, e.g., a graphical lock, spoken password, mouse gesture, biometric password, drag of an IM window to a special region of screen, or drag of an iconic key to the IM window.

It is to be understood that the present invention, in accordance with at least one presently preferred embodiment, includes elements that may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An apparatus for managing viewability of displayable items, said apparatus comprising:
an arrangement for automatically ascertaining whether a displayable item is viewed or potentially viewable by at least one unauthorized individual; and
an arrangement for managing viewability of a displayable item, responsive to said ascertaining arrangement.

2. The apparatus according to claim 1, wherein said arrangement for managing viewability acts to ensure that at least a portion of a displayable item is viewable solely to one or more authorized individuals.

3. The apparatus according to claim 2, wherein said arrangement for managing viewability acts to ensure that at least a portion of a displayable item is viewable solely to one or more authorized individuals at a local displaying medium and not at a public displaying medium.

4. The apparatus according to claim 3, wherein:
the local displaying medium comprises at least one of: a desktop computer, a laptop computer and a handheld device.

5. The apparatus according to claim 4, wherein the local displaying medium comprises a handheld device which comprises a cell phone or PDA.

6. The apparatus according to claim 3, including at least one of:
said public displaying medium comprising a projector; and
said ascertaining arrangement acting to detect a shared screen presentation.

7. The apparatus according to claim 1, wherein said ascertaining arrangement acts to detect whether an unauthorized individual is looking at a display medium which displays a displayable item.

8. The apparatus according to claim 1, wherein:
said ascertaining arrangement acts to detect content of a displayable item; and
said arrangement for managing viewability acts to suppress viewability of a displayable item based on a confidential aspect of a displayable item

9. The apparatus according to claim 1, wherein said arrangement for managing viewabilty acts to:
manage viewability at a multiple display arrangement;
employ hardware or software;
ascertain pixels to be displayed on different displays of a multiple display arrangement, at least via detecting window opens and closes; and
determine one or more windows to be displayed on different displays for a multiple display arrangement.

10. The apparatus according to claim 9, wherein said arrangement for managaing viewability acts to employ one of:
hardware comprising a frame buffer; and
software comprising networked software which provides multiple desktops.

11. The apparatus according to claim 1, wherein said arrangement for managing viewability acts to:
employ events reflecting screen sharing state changes;
dispatch the events to applications which function in accordance with screen sharing state changes and which are registered in a shared screen event state registry.

12. The apparatus according to claim 1, wherein the displayable item comprises an instant message; and
said arrangement for managing viewability acts to employ an access control mechanism which defers display of an instant message until access is permitted.

13. The apparatus according to claim 12, wherein the access control mechanism comprises at least one of: a graphical cipher lock; a graphical keypad; a dial; a typed password; a spoken password; a biometric password; a predetermined mouse gesture; a drag and drop of an iconic key to the instant message window; and a drag and drop of the instant message window to a predetermined screen region.

14. The apparatus according to claim 12, wherein said arrangement for managing viewability acts to reroute an instant message to another location.

15. The apparatus according to claim 12, wherein:
said ascertaining arrangement acts to analyze an instant message and determine a status or level of priority; and
said arrangement for managing viewability acts to perform at least one of:
rerouting or permitting access to an instant message to one or more different destinations based on status or level of priority;
seeking confirmation of a status or level of priority of an instant message; and
grouping messages in accordance with one or more predetermined criteria.

16. A method of managing viewability of displayable items, said method comprising the steps of:
automatically ascertaining whether a displayable item is viewed or potentially viewable by at least one unauthorized individual; and
managing viewability of a displayable item, responsive to said ascertaining step.

17. The method according to claim 16, wherein said step of managing viewability comprises ensuring that at least a portion of a displayable item is viewable solely to one or more authorized individuals.

18. The method according to claim 17, wherein said step of managing viewability comprises ensuring that at least a portion of a displayable item is viewable solely to one or more authorized individuals at a local displaying medium and not at a public displaying medium.

19. The method according to claim 16, wherein the displayable item comprises an instant message; and
said step of managing viewability comprises employing an access control mechanism which defers display of an instant message until access is permitted.

20. A program storage device readable by machine, tangibly embodying a program of instructions executable by the machine to perform method steps for managing viewability of displayable items, said method comprising the steps of:
automatically ascertaining whether a displayable item is viewed or potentially viewable by at least one unauthorized individual; and
managing viewability of a displayable item, responsive to said ascertaining step.
